(19) United States
(12) Patent Application Publication
(10) Pub. No.: US 2011/0047756 A1
(43) Pub. Date: Mar. 3, 2011

(54) Reversing Handle Structure

(76) Inventors: Fangchang Fan, Tianjin (CN); Jialiang Wang, Tianjin (CN); Qi Yang, Tianjin (CN)

(21) Appl. No.: 12/548,442

(22) Filed: Aug. 27, 2009

(51) Int. Cl. E05B 1/02

(52) U.S. Cl. 16/413

(57) ABSTRACT

The reversing handle structure according to the present invention includes: a handle and a handle seat. A mounting hole is formed at the end of the handle and the mounting pivot is assembled with the handle seat. The mounting hole can be set into the mounting pivot so as to assemble the handle with the handle seat. Herein, the mounting pivot has a symmetrical shape along its long axis. The size of the mounting hole is corresponding to that of the mounting pivot. The mounting hole is set into the mounting pivot of the handle seat before or after the handle is reversed horizontally. The reversing handle structure according to the present invention is adapted to various door structures which have different open directions, which can greatly facilitates the users.

### BACKGROUND OF THE INVENTION

1. Field of the Invention

The present invention generally relates to a handle structure of the lock, and in particular to a reversing handle structure.

2. The Prior Arts

In order to open the door toward different directions, the lock which is widely used recently is equipped with different handles. That is, the indoor and the outdoor handles are for the left-handed open door and the right-handed open door respectively, which resulted in many types of the handles.

The reversing for some handles can be achieved by exchanging the indoor handles with the outdoor handles, however, the indoor and the outdoor handles with different structure can not be easily exchanged. Therefore, there are significant limitations to the handle structure of the conventional locks.

### SUMMARY OF THE INVENTION

An objective of the present invention is to provide a reversing handle structure, which can be assembled in the lock adaptable to the left-handed open door or the right-handed open door.

The reversing handle structure according to the present invention includes: a handle and a handle seat. A mounting hole is formed at the end of the handle and the mounting pivot is assembled with the handle seat. The mounting hole can be set into the mounting pivot so as to assemble the handle with the handle seat. Herein, the mounting pivot has a symmetrical shape along its vertical axis. The size of the mounting hole is corresponding to that of the mounting pivot. The mounting hole of the handle is set into the mounting pivot of the handle seat, or is set into the mounting pivot of the handle seat after the handle is reversed horizontally.

In the reversing handle structure according to the present invention, a hole is formed at the end of the handle and through the wall of the mounting hole.

A hole is formed on the side wall of the mounting pivot.

And, when the mounting hole of the handle is set into the mounting pivot of the handle seat, a fixed member is passed through the hole of the handle and the hole of the mounting pivot.

In the reversing handle structure according to the present invention, the end of the mounting pivot has a hollow section corresponding to a boss of the lock group. There is a positioning groove formed on the side wall of the lock group which is inserted into the hollow section of the mounting pivot.

A hole formed on the side wall of the mounting pivot is a through hole.

The inner wall of the hole formed at the end of the handle has the female thread.

The back-end of the fixed member has the male thread matched with the female thread. Thus, after the fixed member is screwed into the hole formed at the end of the handle, the front-end of the fixed member is passed through the hole of the mounting pivot so as to resist the positioning groove formed on the side wall of the lock group.

In the reversing handle structure according to the present invention, a ring-type gasket is disposed on the hole formed at the end of the handle and has a hollow section of which diameter is smaller than that of the fixed member. The front-end of the fixed member is in the hole formed on the side wall of the mounting pivot, while the back-end is above the top surface of the ring-type gasket.

In the reversing handle structure according to the present invention, two embosses are formed on the side wall of the lock group and corresponding to two grooves formed inside the hollow section of the mounting pivot. Two positioning platforms are formed at the ends of two grooves. When the lock group is inserted into the hollow section, two embosses are slide to the positioning platforms along two grooves.

In the reversing handle structure according to the present invention, there is a positioning slit formed on the side wall of the lock group between the embosses and the boss and be in line with the emboss. When the lock group is inserted into the hollow section, the positioning slit is matched with the positioning grooves of the hollow section.

In the reversing handle structure according to the present invention, the cross-section of the mounting pivot is a hexagon shape, and the upper and lower opposed sides are longer than the remaining four sides.

The reversing handle structure according to the present invention is adapted to various door structures which have different open directions, which can greatly facilitates the user.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded diagram showing a bathroom lock equipped with the reversing handle in accordance with the present invention;

FIG. 2 is a cross-sectional view showing the bathroom lock of FIG. 1;

FIG. 3 is an exploded diagram showing a passage lock equipped with the reversing handle in accordance with the present invention;

FIG. 4 is a cross-sectional view showing the passage lock of FIG. 2;

FIG. 5 is a schematic diagram showing the reversing handle in accordance with the present invention mounted to the handle seat;

FIGS. 6 through 8 are schematic diagrams showing a process of the reversing handle being mounting to the handle seat.

### DETAILED DESCRIPTION OF THE PREFERRED EMBODIMENT

Reference will now be made in greater detail to preferred embodiments of the invention, examples of which are illustrated in the accompanying drawings. Wherever possible, the same reference numerals will be used throughout the drawings and the description to refer to the same or like parts.

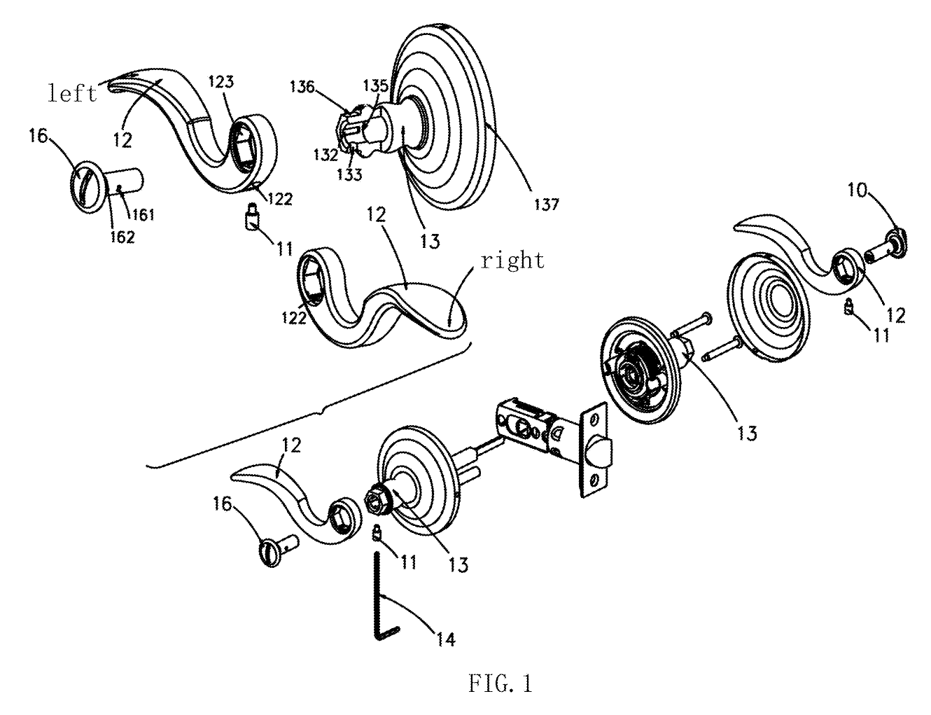

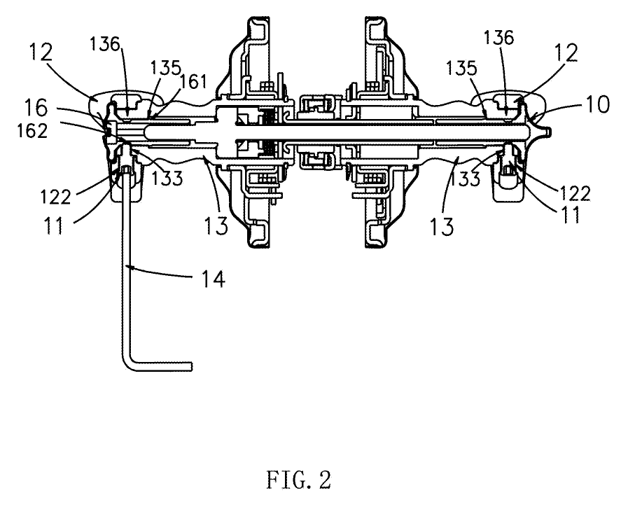

FIG. 1 is an exploded diagram showing a bathroom lock equipped with the reversing handle in accordance with the present invention. FIG. 2 is a cross-sectional view showing the bathroom lock of FIG. 1. With reference to FIG. 1 and FIG. 2, the reversing handle structure according to the present invention includes a handle 12 and a handle seat 13. Herein, the handle 12 can be arranged in a right-handed position or in left-handed position which are mirror symmetry to each other. That is, the present surface shape of the handle 12 is the same as the surface shape of the handle 12 which has been horizontally reversed. The handle 12 can be formed into any shapes adaptable for being held by users, and there is a mounting hole 123 formed at an end of the handle 12.

A mounting pivot 136 is inserted into a casing spider 137 so as to assemble with other members. The mounting pivot 136 has a symmetrical shape along its long axis, e.g. a cylindrical shape, a diamond shape or a regular hexagon shape. Since the size of the mounting hole 123 is corresponding to that of the mounting pivot 136, the mounting hole 123 can be set into the mounting pivot 136 so as to assemble the handle 12 with the handle seat 13. Therefore, the mounting hole 123 of the handle 12 either is set into the mounting pivot 136 directly, or is set into the mounting pivot 136 after the handle 12 has been reversed horizontally. The reversing handle structure of the present invention is adapted to various doors which have different open directions, such that manufacturers can meet variety of demands only by producing a lock which is assembled with the reversing handle structure of the present invention, and the production cost is reduced. In the case of the uses, they can adjust the direction of the handle according to the actual need and no longer need to worry about the open direction of the door.

After the handle 12 has been mounted to the mounting pivot 136, the holding part of the handle 12 should be arranged at the horizontal level, such that the users can feel comfortable when holding the handle 12, thereby, it is necessary to further determine the shape of the mounting pivot 136. In case the cross-section of the said mounting pivot 136 has a hexagon shape, two opposite sides are longer than the remaining four sides. When the handle 12 is arranged at the horizontal level, the two opposite sides of the mounting hole 123 corresponding to the mounting pivot 136 are still longer than the remaining four sides. That is to say, whenever the handle 12 is mounted to the mounting pivot 136 before or after reversing, the holding part of the handle 12 is maintained at the horizontal level.

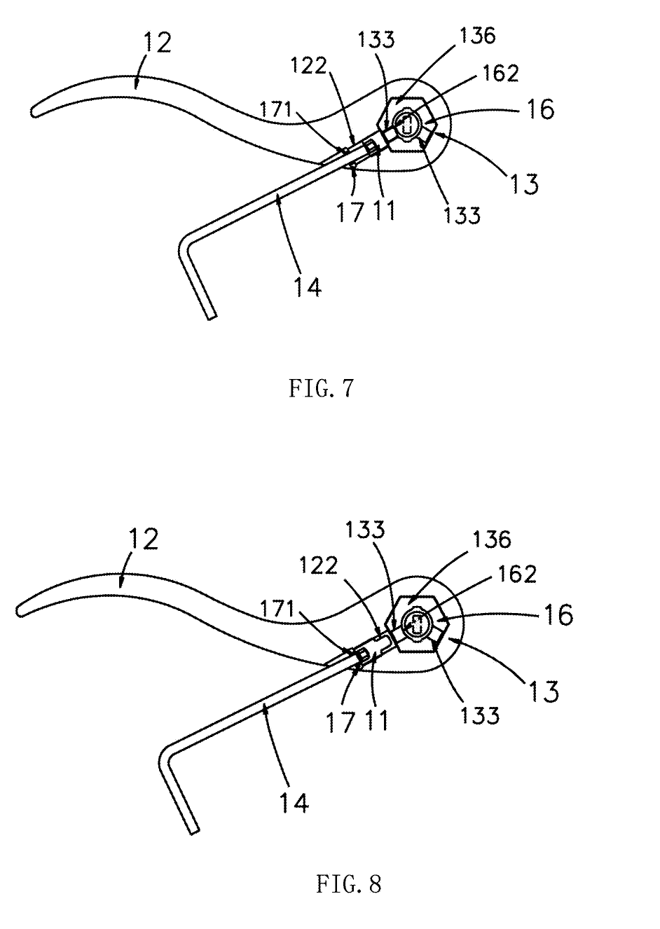

Furthermore, to make the handle 12 mounted to the handle seat 13 firmly, a hole 122 can be formed at the end of the handle 12 and through the wall of the mounting hole 123, while a hole 133 can be formed on the side wall of the mounting pivot 136 and corresponding to the hole 122. When the mounting hole 123 is set into the mounting pivot 136, the holes 122 and 133 are in alignment. At this time, a fixed member 11 is passed through the holes 122 and 133, such that the handle 12 can be assembled with the mounting pivot 136. That is, the handle 12 is mounted to the handle seat 13. There can be one hole 133 formed on the long axis of the mounting pivot 136. Selectively, there can be two holes 133 (as shown in FIG. 6) formed on the mounting pivot 136 in a mirror symmetry, and thus the hole 122 of the handle 12 is still in the alignment with one of two holes 133 whether the handle 12 is reversed horizontally or not.

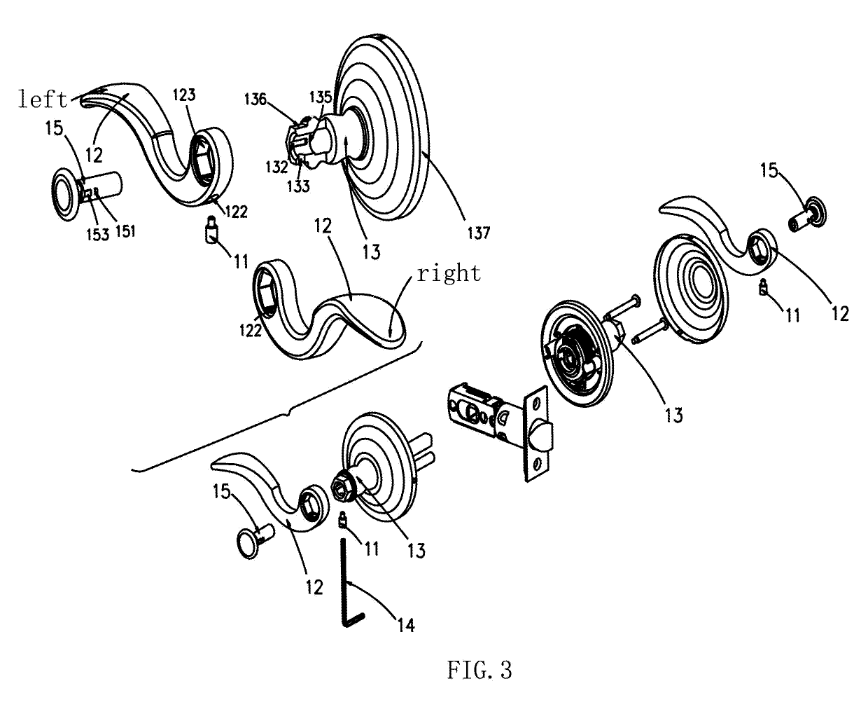

The said locks have various functions by assembling with various lock groups. For example, when the urgent lock group 16 is disposed on the mounting pivot 136, the lock thus constitutes the outside lock of the bathroom lock; or when the switch button group 10, as shown in FIG. 2, is disposed on the mounting pivot 136, the lock thus constitutes the inside lock; or when the urgent lock group 16 and the switch button group 10 are respectively replaced with the design lock group 15, as shown in FIG. 3, the design lock group 15 with the positioning slit 153 disposed on the side wall thereof is inserted into the hollow section of the mounting pivot 136, the positioning slit 153 can match with the groove 132 inside the hollow section, such that the design lock group 15 is positioned and the lock can maintain the unlock state perpetually, i.e. a passage lock.

Referring to FIG. 1, in the case that the lock group is the urgent lock group 16, the end of the mounting pivot 136 has a hollow section corresponding to a boss of the urgent lock group 16. There is a ring-type positioning groove 162 formed on the side wall of the urgent lock group 16. The hole 133 formed on the side wall of the mounting pivot 136 is a through hole across the hollow section. And, the inner wall of the hole 122 formed at the end of the handle 12 has the female thread, while the back-end of the fixed member 11 has the male thread matched with the female thread of the hole 122. Thus, after the urgent lock group 16 is inserted into the hollow section, the fixed member 11 is screwed into the hole 122 by matching the female thread with the male thread. In details, as shown in FIG. 2, the fixed member 11 is firstly passed through the hole 122 and the hole 133, then against the positioning groove 162. Therefore, the urgent lock group 16 can not be fallen off from the mounting pivot 136, but also is reversible in the hollow section of the mounting pivot 136, which can meet the function requirements of the bathroom lock.

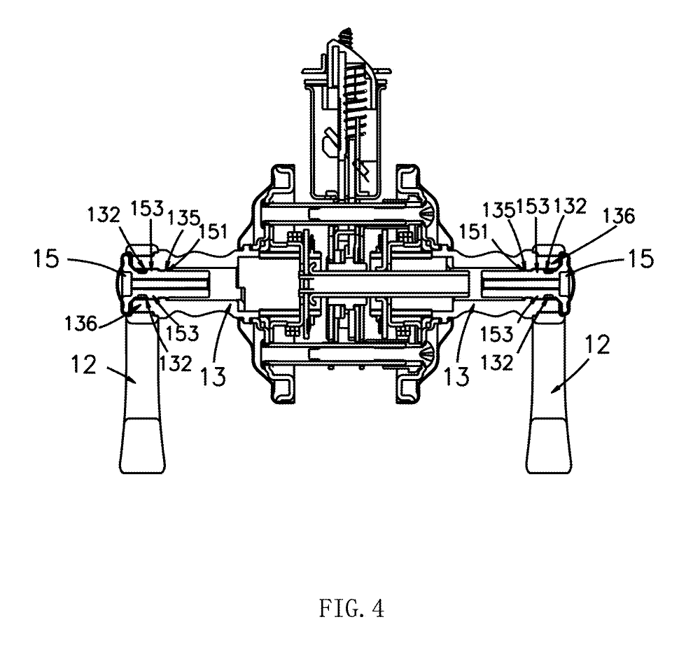

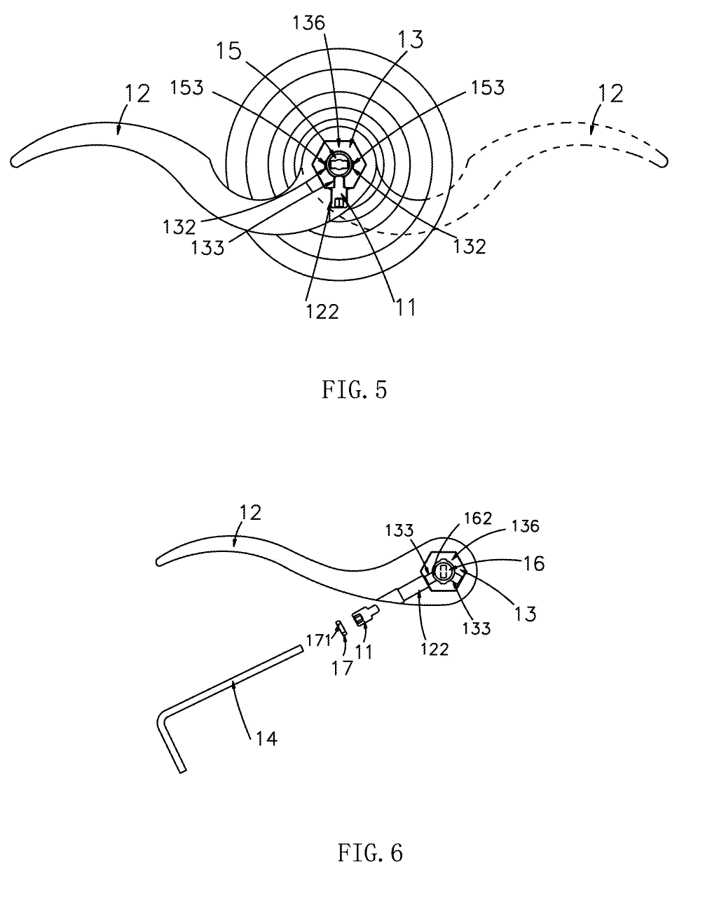

FIG. 3 is an exploded diagram showing a passage lock equipped with the reversing handle according to the present invention. FIG. 4 is a cross-sectional view showing the passage lock of FIG. 3. FIG. 5 is a schematic diagram showing the reversing handle in accordance with the present invention mounted to the handle seat. With reference to FIG. 3, when the lock group is the reversible design lock group 15, there is the positioning slit 153 formed on the side wall of the design lock group 15 between the emboss 151 and the boss and in line with the emboss 151. In details, as shown in FIG. 4 and FIG. 5, when the design lock group 15 is inserted into the hollow section of the mounting pivot 136, the positioning slit 153 is matched with the grooves 132 so as to be positioned, which make the lock in the unlock state perpetually, so as to constitute the passage lock.

FIGS. 6 through 8 are schematic diagrams showing a process of the reversing handle being mounting to the handle seat. With reference to FIG. 6, FIG. 7 and FIG. 8, the fixed member 11 can be taken off from the hole 122 by a hexagon wrench 14. Since the fixed member 11 is so small, the ring-type gasket 17 should be disposed on the hole 122 to prevent the fixed member 11 from being lost, as shown in FIG. 7. The ring-type gasket 17 has a hollow section 171 with a smaller diameter than that of the fixed member 11, which prevent the fixed member 11 from falling off from the hollow section, and can be screwed up or down by using the hexagon wrench 14. After the fixed member 11 is disassembled, the urgent lock group 16 can be taken off from the mounting pivot 136. At this time, the front-end of the fixed member 11 is taken off from the positioning groove 162 into the through hole 133, while the back-end is above the top surface of the ring-type gasket 17, which form a space in the hole 122 and the hole 133 for the fixed member 11 moving up and down.

Referring to FIG. 1 and FIG. 2, to make the urgent group lock 16 insert into the hollow section of the mounting pivot 136 and reach the effective position, two embosses 161 can be formed on the side wall of the urgent lock group 16 and corresponding to two grooves 132 formed inside the hollow section of the mounting pivot 136, such that the urgent group lock 16 can be inserted into the hollow section of the mounting pivot 136. In addition, two positioning platforms 135 are formed at the ends of two grooves 132. When the urgent lock group 16 is inserted into the hollow section of the mounting pivot 136, two embosses 161 are slide along two grooves 132 and reach the position platforms 135, so as to position the urgent lock group 16 effectively.

Hereinafter, the mounting process of the reversing handle according to the present invention should be simply described with reference to the case of the urgent lock group 16.

Back to FIG. 1 and FIG. 2, the mounting hole 123 which is formed at the end of the handle 12 is firstly set into the mounting pivot 136 of the handle seat 13. In case the mounting pivot 136 is a hexagon shape, since two opposite sides are longer than the remaining four sides, the handle 12 is only set into the mounting pivot 136 horizontally, or is set into the mounting pivot 136 after the handle 12 has been reversed horizontally, which make the mounting direction of the handle 12 accurate, as shown in FIG. 5.

When the urgent lock group 16 is mounted to the hollow section of the mounting pivot 136, two embosses 161 and two grooves 132 are matched with each other, the urgent lock group 16 thus can be mounted by being pushed to the effective position. At this time, two positioning platforms 135 can be resisted by two embosses 161.

Meanwhile, the positioning grooves 162 of the urgent lock group 16 is aligned with the hole 133 and the hole 122, and thus the fixed member 11 can be screwed up by the hexagon wrench 14. After that, the fixed member 11 is passed through the hole 122 and then the hole 133 so as to resist the positioning grooves 162.

So far, the process of the reversing handle being mounting to the handle seat is accomplished. If the handle should be reversed, the fixed member 11 can be screwed down by the hexagon wrench 14. At this time, the handle 12 and the urgent lock group 16 can be taken off by using the external force along the central axis of the mounting pivot 136. Thereby, the handle 12 can be mounted to the handle seat again after the handle 12 is reversed as required.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A reversing handle structure, comprising: a handle and a handle seat, a mounting hole formed at the end of the handle being set into a mounting pivot of the handle seat,
wherein, the mounting pivot has a symmetrical shape along its long axis and the size corresponding to that of the mounting hole, and then the mounting hole is set into the mounting pivot of the handle seat before or after the handle is reversed horizontally.

2. The reversing handle structure as claimed in claim 1, wherein a hole is formed at the end of the handle and through the wall of the mounting hole,
a hole is formed on the side wall of the mounting pivot;
when the mounting hole of the handle is set into the mounting pivot of the handle seat,
a fixed member is passed through the hole of the handle and the hole of the mounting pivot.

3. The reversing handle structure as claimed in claim 2, wherein a lock group is inserted into the hollow section,
a hollow section is formed at the end of the mounting pivot and corresponding to a boss of a lock group,
a ring-type positioning groove is formed on the side wall of the lock group,
a hole formed on the side wall of the mounting pivot is a through hole;
the inner wall of the hole formed at the end of the handle has the female thread;
the back-end of the fixed member has the male thread matched with the female thread,
and thus when the fixed member is screwed into the hole formed at the end of the handle, the front-end of the fixed member is passed through the hole of the mounting pivot so as to resist the positioning groove formed on the side wall of the lock group.

4. The reversing handle structure as claimed in claim 3, wherein a ring-type gasket is disposed on the hole formed at the end of the handle and a hollow section with a diameter is smaller than that of the fixed member, and thus the front-end of the fixed member is in the hole formed on the side wall of the mounting pivot and the back-end is above the top surface of the ring-type gasket.

5. The reversing handle structure as claimed in claim 3, wherein two embosses are formed on the side wall of the lock group and corresponding to two grooves formed inside the hollow section of the mounting pivot, and two positioning platforms are formed at the ends of two grooves, and thus when the lock group is inserted into the hollow section, two embosses are slide along two grooves 132 and reach the position platforms.

6. The reversing handle structure as claimed in claim 5, wherein there is a positioning slit formed on the side wall of the lock group between the embosses and the boss, and thus when the lock group is inserted into the hollow section, the positioning slit is matched with the positioning grooves of the hollow section.

7. The reversing handle structure as claimed in claim 1, wherein the cross-section of the mounting pivot is a hexagon shape, and two opposite sides are longer than the remaining four sides.
